(19) United States
(12) Patent Application Publication
(10) Pub. No.: US 2026/0213964 A1
(43) Pub. Date: Jul. 23, 2026

(54) SYSTEM AND METHOD FOR ENCRYPTED COMMUNICATION BASED ON NETWORK ADDRESS MUTATION

(71) Applicant: STEALTHSOLUTION CO.,LTD, Seoul (KR)

(72) Inventors: Hyokeun WANG, Seoul (KR); Jeongsang LEE, Seoul (KR); Dongseok SHIN, Seoul (KR); Junseok PARK, Seoul (KR); Jaesung CHOI, Seoul (KR)

(21) Appl. No.: 19/143,619

(22) PCT Filed: Aug. 7, 2023
(86) PCT No.: PCT/KR2023/011542

§ 371 Date: Jun. 26, 2025

(30) Foreign Application Priority Data
Dec. 30, 2022 (KR) 10-2022-0190663
Feb. 3, 2023 (KR) 10-2023-0014687

(51) Int. Cl. H04L 9/40; H04L 9/08; H04L 61/256

(52) U.S. Cl. CPC H04L 9/40; H04L 9/0861; H04L 61/256

(57) ABSTRACT

An embodiment relates to a system and a method for securely moving encrypted communication based on network address mutation. The system may comprise: a policy server for registering and managing a policy for causing mutation of a physical address of a server to be protected; a client terminal that attempts to establish a communication connection with a protection target server using the assigned virtual address by the policy server; and the protection target server including an address mutation server agent configured to mutate the physical address at regular intervals according to a mutation rule distributed from the policy server, in order to transmit or receive packets to or from the client terminal through the hidden tunnel by generating a hidden tunnel so that the communication connection is maintained through the virtual address assigned to the client terminal although the physical address is mutated by the address mutation server agent.

### TECHNICAL FIELD

The present invention relates to a technique of preventing attack behaviors of an attacker in a network environment, and more particularly, to a system and method for securely moving encrypted communication based on network address mutation, which creates a virtual hidden communication channel to maintain a communication connection between a protection target server and a client, while continuously mutating the network address of the protection target server, so that communications encrypted to make the physical address of a server to be accessed completely invisible to the outside are possible.

### BACKGROUND ART

Recently, an era of hyper-connectivity that interconnects all devices around the world, including automobiles, machines, home appliances, and the like, is encountered, and work environments are also constructed smartly according there to.

As existing IP-based Ethernet networks using computer devices have a vulnerability of openness, and there is a problem in that the security threat to data and systems has become bigger than ever. Malicious users such as hackers or the like, as well as normal users, may easily access the networks, and as access to all servers connected to an internal network is possible after connecting to the internal network, there is a huge vulnerability in security.

For example, referring to FIG. 1, an example of a terminal connecting to a specific server through a network is shown. Generally, a terminal connects to a network through a fixed IP address and a port of a server, and the terminal succeeded in connection transmits and receives packet data with a specific server through the network.

At this point, the IP and port are unique network properties assigned when a terminal connects to a network. Although these properties can be exposed to both normal users and hackers, when they are exposed to hackers, there is a room for the attackers to invade using various hacking techniques. That is, when an attacker who accesses for hacking purposes captures a packet, the attacker may readily identify and steal the IP address that the terminal connects to (\textcircled{1}\textcircled{2}).

Furthermore, a terminal succeeded in connection may maintain a state of being connected to the network at all times and may easily access all servers connected to the network, and there is a problem in that, since a terminal remains connected to the network in this way, an attacker can easily gain access, thereby significantly increasing the risk of exposure to security attacks (\textcircled{3}).

In order to prevent such cyber-attacks, devices connected to the Internet should be designed to actively defend by themselves. System designed in this way can perform appropriate defense functions without a firewall, and can also prevent hackings on the server and block DDOS attacks or the like in advance.

For the sake of such active security, the present invention applies a network address mutation technique that blocks various cyber-attacks in advance by changing network properties of a protection target server to confuse attackers to detect multiple connection addresses or not to give the attackers a chance of specifying a connection address.

### DISCLOSURE OF INVENTION

### Technical Problem

Therefore, the present invention has been made in view of the above problems, and it is an object of the present invention to provide a system and method for securely moving encrypted communication based on network address mutation, which creates a virtual hidden communication channel to maintain a communication connection between a protection target server and a client, while continuously mutating the actual address and port of the protection target server at short intervals, to provide a dual encryption communication channel so that the actual address of a server to be accessed is not exposed at all to the outside.

In addition, another object of the present invention is to provide a method of preventing an attacker from acquiring a valid communication channel before the address mutation period (cycle) of numerous networks is changed through a network address mutation technique and a virtual hidden communication channel, although the attacker attempts hacking by stealing packets between a client and a protection target server during a passive attack.

The technical problems to be solved in the present invention are not limited to the technical problems mentioned above, and unmentioned other technical problems will be clearly understood by those skilled in the art from the following descriptions.

### Technical Solution

To accomplish the above objects, according to one aspect of the present invention, there is provided a system for securely moving encrypted communication based on network address mutation, the system comprising: a policy server for registering and managing a policy for mutating a physical address of server on the basis of service information, address mutation cycle and range, and life cycle provided by the server; a client terminal which, upon successful authentication, is assigned a virtual hidden address enabling access a protection target server desired by a terminal from the policy server, and attempts to establish a communication connection with the protection target server using the assigned virtual address; and the protection target server including an address mutation server agent configured to receive, from the policy server, a policy of mutating a physical address of a corresponding server, and to mutate the physical address at regular intervals according to a mutation rule of the policy, in order to transmit or receive packets to or from the client terminal through the hidden tunnel by generating a hidden tunnel so that the communication connection is maintained through the virtual address assigned to the client terminal although the physical address is mutated by the address mutation server agent, wherein dual encryption communication is enabled so that the physical address that capable of accessing the protection target server is not exposed to the outside.

At this point, the client terminal of the system for securely moving encrypted communication based on network address mutation according to an embodiment of the present invention includes: a tracking module for receiving a policy corresponding to the protection target server from the policy server, and tracking the physical address of the protection target server with reference to the mutation rule of the policy when attempting a communication connection with the protection target server; a Network Address Translation (NAT) for address-translating the assigned virtual address into a physical address of the protection target server tracked through the tracking module; and a physical NIC for transmitting packets to the physical address address-translated by the NAT.

The tracking module continuously may track the physical address of the protection target server mutated at regular intervals according to the mutation rule of the policy, and update an NAT table.

In the system for securely moving encrypted communication based on network address mutation according to an embodiment of the present invention, the protection target server includes: a server-side NIC for receiving packets from the NIC of the client terminal; a server-side NAT for address-translating the physical address back into the virtual address to send the packets transferred to the server-side NIC through the virtual hidden tunnel; and a virtual NIC for transferring packets of the virtual address address-translated by the server-side NAT to the virtual hidden tunnel.

At this point, when transmitting a response packet to the client terminal, the protection target server sets the virtual address connected to the client terminal as a source address, address-translates the virtual address of the source address into a physical address through the NAT, and then transmits the packets to the physical Ethernet of the client terminal through the server-side NIC.

In addition, when translating the virtual address of the source address into a physical address, the protection target server address-translates the address into a physical address address-translated through the address mutation server agent, and the client terminal receives packets from the protection target server with reference to the physical address of the server, of which the tracking has been updated through the tracking module, without receiving information on the address-mutated physical address from the protection target server.

In the system for securely moving encrypted communication based on network address mutation according to an embodiment of the present invention, the address mutation server agent can extend the address mutation range by further including a source port number of the protection target server, in addition to the IP address and port number of the protection target server.

In addition, in the system for securely moving encrypted communication based on network address mutation according to an embodiment of the present invention, when the address mutation cycle of the protection target server changes before the packets transmitted from the client terminal arrive at the protection target server, the address mutation server agent may guarantee to accept, for a short period of time before and after the address mutation cycle is changed, the packets received through the physical address before the change of address mutation cycle, or the tracking module of the client terminal may be set to delete connection tracking information before and after the mutation cycle when the client terminal attempts to retransmit a failed packet using an updated physical address so that the packets are not deadlocked by the NAT table before the mutation cycle when the packets are retransmitted.

In addition, the system for securely moving encrypted communication based on network address mutation according to an embodiment of the present invention further comprises an authentication server for generating a secret key for the protection target server, performing a user authentication process with the client terminal, and distributing the secret key and policy for a protection target server desired by the client terminal to the client terminal that succeeds in authentication, wherein the address mutation server agent performs address mutation by generating a random value using the secret key generated through the authentication server.

On the other hand, an method for securely moving encrypted communication based on network address mutation according to an embodiment of the present invention comprises the steps of: registering a policy for mutating a physical address of a protection target server in a policy server on the basis of service information, address mutation cycle and range, and life cycle provided by the protection target server; receiving a policy of a corresponding server from the policy server through an address mutation server agent, and mutating the physical address of the server at regular intervals according to a mutation rule of the policy, by the protection target server; being assigned a virtual hidden address for accessing a protection target server desired by a client terminal from the policy server, and attempting a communication connection with the protection target server using the assigned virtual address, by the client terminal; and generating a hidden tunnel so that the communication connection is maintained through the virtual address assigned to the client terminal although the physical address is mutated through the address mutation server agent, and receiving packets transmitted from the client terminal through the hidden tunnel, by the protection target server, wherein dual encryption communication is enabled so that the physical address capable of accessing the protection target server is not exposed to the outside.

In the method for securely moving encrypted communication based on network address mutation according to an embodiment of the present invention, the step of attempting a communication connection with the protection target server using the assigned virtual address by the client terminal includes the steps of: receiving a policy corresponding to the protection target server from the policy server, and tracking the physical address of the protection target server with reference to the mutation rule of the policy when attempting a communication connection with the protection target server, by the tracking module of the client terminal; address-translating the assigned virtual address into a physical address of the protection target server tracked through the tracking module, through Network Address Translation (NAT), by the client terminal; and transmitting packets to the address-translated physical address through Ethernet, by the client terminal.

In addition, the method for securely moving encrypted communication based on network address mutation according to an embodiment of the present invention may further comprise the step of continuously tracking the physical address of the protection target server mutated at regular intervals according to the mutation rule of the policy, and updating an NAT table, by the tracking module of the client terminal.

In addition, in the method for securely moving encrypted communication based on network address mutation according to an embodiment of the present invention, the step of receiving packets transmitted from the client terminal by the protection target server includes the steps of: receiving packets from the Ethernet of the client terminal through server-side Ethernet, by the protection target server; address-translating the physical address back into the virtual address through a server-side NAT so that the packets transferred to the server-side Ethernet are sent through the virtual hidden tunnel, by the protection target server; and transferring the packets of the address-translated virtual address to the virtual hidden tunnel through the virtual Ethernet, by the protection target server.

### Advantageous Effects

According to an embodiment of the present invention, there is an effect of providing a dual encryption communication channel by creating a virtual hidden communication channel to maintain a communication connection between a protection target server and a client, while continuously mutating the actual address of the protection target server at short intervals, so that the actual address of a server to be accessed is not exposed to the outside at all.

The network address mutation technique applied to the embodiment of the present invention is a technique of specifying an attack target through a network and disconnecting the linkage of a step-by-step attack procedure from vulnerability analysis to actual attack, and has the following effects.
Suppression of all attack activities through network active scanning
Suppression of all attack activities through network passive scanning (packet sniffing, etc.)
Detection of deterministic and highly sensitive network scanning attacks based on trust relationships
Detection of Advanced Persistent Threats and suppression of attack activities
Suppression of attack activities according to infection by new and variant malware such as ransom ware or the like
Management of network connection and separation according to policy allocation between an address tracking host and an address mutation server (network connection and network separation effect)
Concealment of communication channel through multiplexing of communication paths based on encryption (SSL, etc.)
Automatic discard of DDoS packets based on the principle of packet path change and automatic filtering of packets from unauthorized/unauthenticated hosts according to address mutation

All network scanning attacks can be suppressed simply by mutating the address of a network server very quickly (e.g., in seconds), and furthermore, according to the encrypted communication system based on network address mutation according to an embodiment of the present invention, an effect of deterministically determining an attack as soon as the attack occurs by tracking and managing the connection relationship between a virtual address and a continuously mutating real address.

In addition, according to an embodiment of the present invention, since network tunneling of moving tunnel networking (MTN) is implemented only by configuring a local NAT of a protection target server and a client, unlike general network tunneling based on packet encapsulation, reconstruction of a middlebox or a kernel for additional network layering is not required.

### BRIEF DESCRIPTION OF THE DRAWINGS

FIG. 1 is a view showing the problems of a typical Ethernet-based network.

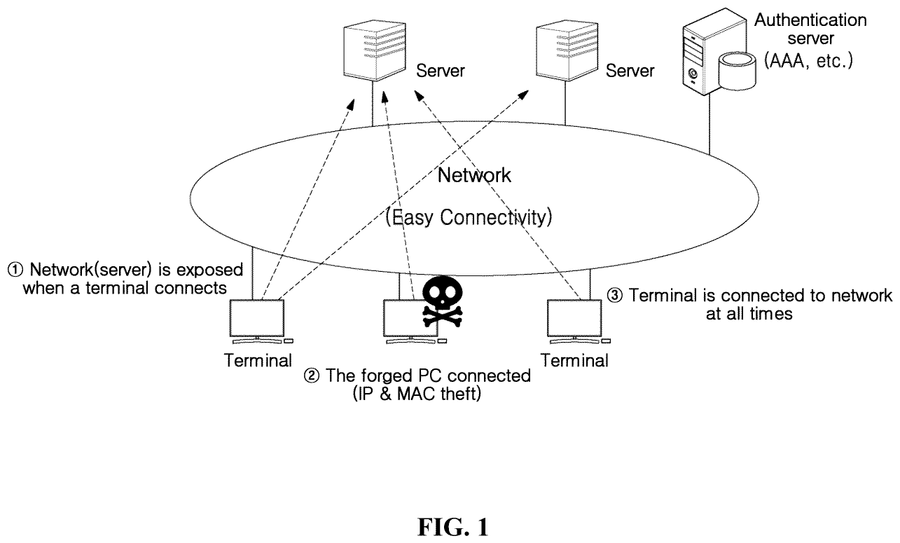

FIG. 2 is a view showing the overall configuration of an encrypted communication system based on network address mutation according to an embodiment of the present invention.

FIG. 3 is a view for explaining the concept of preventing intrusion of an attacker through an encrypted communication system based on network address mutation according to an embodiment of the present invention.

FIG. 4 is a view showing the architecture of a terminal and a server for accessing a virtual hidden tunnel using network address mutation according to an embodiment of the present invention.

FIG. 5 is a view showing an example of translating an address to transmit packets from a client terminal to a protection target server through the architecture of FIG. 4.

FIG. 6 is a view showing an example of translating the address of a packet in a protection target server to respond to a client terminal through the architecture of FIG. 4.

FIG. 7 is a view showing a configuration of mutating an address through a policy server in a system according to an embodiment of the present invention.

FIG. 8 is a view showing an algorithm for random address generation in the policy server of FIG. 7.

FIG. 9 is a view for explaining an example of a failed virtual connection in a system according to an embodiment of the present invention.

FIG. 10 is an overall flowchart for explaining an encrypted communication method based on network address mutation according to an embodiment of the present invention.

FIG. 11 is a flowchart for explaining an authentication process between a client terminal and an authentication server in an encrypted communication method according to an embodiment of the present invention.

### BEST MODE FOR CARRYING OUT THE INVENTION

Hereinafter, the present invention will be described in more detail with reference to the drawings.

Before explaining the present invention, the network address mutation technique applied to the present invention will be described.

Since an intelligent attack is configured of a series of steps such as an intrusion kill chain, when a specific step is blocked, the attack will fail.

In accordance there to, the Moving Target Defense (MTD) technique actively researched and developed recently is an active preemptive security strategy technique that blocks the steps configuring the intrusion kill chain of a cyber-attack by changing major properties (network, operating system, software, data, runtime environments, etc.) of a protection target.

Among the MTD strategies, the Network Address Mutation technique is a technique that actively mutates the network address (IP, Port) of a protection target. It can be an effective security technique that may abruptly increase the cost required for the reconnaissance behavior, which is the first step of the intrusion kill chain.

Specifically, the network address mutation technique does not give a time (enough time) for specifying an attack address by continuously changing the network address at regular intervals. It performs a function of blocking various attacks in advance by making it impossible to specify an attack target and preventing the attack behavior itself.

In reality, the information that an attacker needs to connect to a server is a destination IP address (xxx.xxx.xxx.xxx) and a port number. However, since 253 IP addresses and 2¹⁶ (65,535) port numbers can be assigned on the basis of D class of IP, the number of cases of mutating the network address with the combination of the IP address and the port number is as complex as to exceed 15 million approximately. Therefore, it can be a structure that is impossible for an attacker to find the IP address and the port within the address mutation cycle no matter how fast the attacker scans.

Accordingly, the network address mutation technique can be said to be much more secure than existing networks that allow relatively sufficient time for preparing an attack.

The present invention proposes a configuration that makes encrypted communication possible by utilizing the Network Address Translation (NAT) function using translation between an actual IP address and a virtual IP address on the basis of the network address mutation technique.

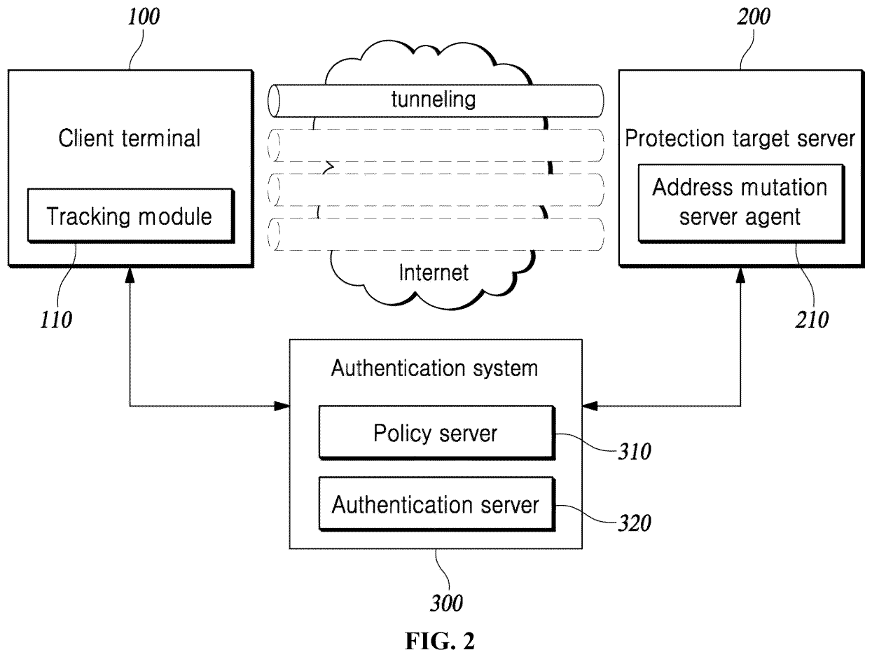

FIG. 2 is a view showing the overall configuration of an encrypted communication system based on network address mutation according to an embodiment of the present invention.

The encrypted communication system based on network address mutation according to an embodiment of the present invention basically includes a client terminal 100, a protection target server 200, and an authentication system 300. The authentication system 300 is configured of a policy server 310 and an authentication server 320.

The authentication system 300 authenticates the client terminal 100 and the protection target server 200 through the authentication server 320.

In order to perform authentication with the client terminal 100, the authentication server 320 assigns identification information for identifying the terminal through membership registration of the client terminal 100, and performs authentication using the assigned identification information. For example, an OTP, a phone number, or the like of each user may be applied as the identification information.

The authentication server 320 generates a secret key for each protection target server 200, and distributes and shares the secret key of the protection target server 200 to the client terminal 100 that has succeeded in authentication. At this point, the authentication server 320 receives a selection of a service that the terminal desires to use from the client terminal 100 that has succeeded in authentication, and distributes the secret key of the protection target server corresponding to the input service.

In addition, the authentication server 320 requests the policy server 310 to distribute the policy of the protection target server that the client terminal desires to use to the client terminal 100 that has succeeded in authentication. Alternatively, the authentication server 320 distributes the policy of the protection target server together with the secret key of the protection target server in association with the policy server 310.

The policy server 310 registers and manages a policy for mutating the physical address of a server on the basis of service information, address mutation cycle and range, and lifecycle provided by the protection target server. Policy registration is performed through a registration procedure between the policy server 310 and the protection target server 200, and after the registration is completed, the previously registered policy of the server is distributed to and shared with the client terminal 100 and the protection target server 200 that have gone through the authentication.

Then, the protection target server 200 periodically mutates the physical address of the server according to the mutation rule of the policy distributed from the policy server 310, and the client terminal 100 may track the physical address of the server, of which the address has been mutated according to the mutation rule of the distributed policy. To this end, the protection target server 200 includes an address mutation server agent 210 that periodically mutates the physical address of the server according to the mutation rule of the policy distributed from the policy server 310, and the client terminal 100 includes a tracking module 110 that has a tracking function. The tracking module 110 may continuously track the physical address of the server mutated at regular intervals according to the mutation rule of the policy, and update the NAT table.

Through the configuration like this, the protection target server 200 randomly mutates the physical address of the server at regular intervals so that the address of the server, which is a target of an attack, cannot be identified from the outside, and may not provide information about this to the client terminal 100. That is, the client terminal 100 may know the physical address of the protection target server through the tracking function although it does not receive information on the address-mutated physical address from the protection target server 200.

Here, the network address includes an IP address and a port, and the physical address includes an external IP address and an external port number bound to the physical network interface controller (NIC) of the protection target server 200. Address mutation of the physical address also means changing the external IP address and external port number.

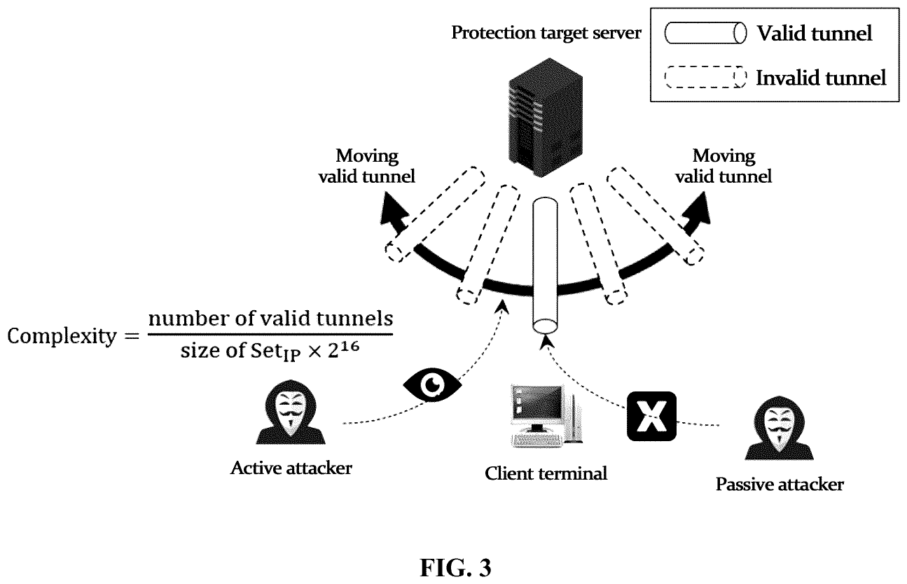

In this way, when the external address is changed, as shown in FIG. 3, there exist many tunnels through which the client terminal 100 may access the protection target server 200. The tunneling indicated by the solid line shows valid tunnels, and the tunneling indicated by the dotted line shows invalid tunnels. Although the total number of tunnels is large, it does not mean that all the network tunnels can be used, and only as many tunnels as the number of network services of the server are valid, and the other tunnels cannot be used. The identifier of each valid tunnel changes periodically. In this embodiment, the protection target server is assigned one IP set among several IP addresses. The number of elements of the IP set is n (IP set), and can be, for example, 253 on the basis of D class of the IP. In addition, since 2¹⁶ (65,535) ports can be assigned to each IP address, the total number of tunnels is n (IP set)*2¹⁶.

At this point, the client terminal accurately identifies a valid tunnel identifier at all times through previous authentication based on Zero Trust, and although an attacker can find a valid tunnel identifier for a predetermined period of time, as the tunnel identifier changes during the next address mutation cycle, a valid tunnel identifier for kill chain connection cannot be maintained. Although the probability of an attacker for finding a valid tunnel identifier for a predetermined period of time increases over time, the probability of finding a valid tunnel identifier is reset when the address mutation cycle changes.

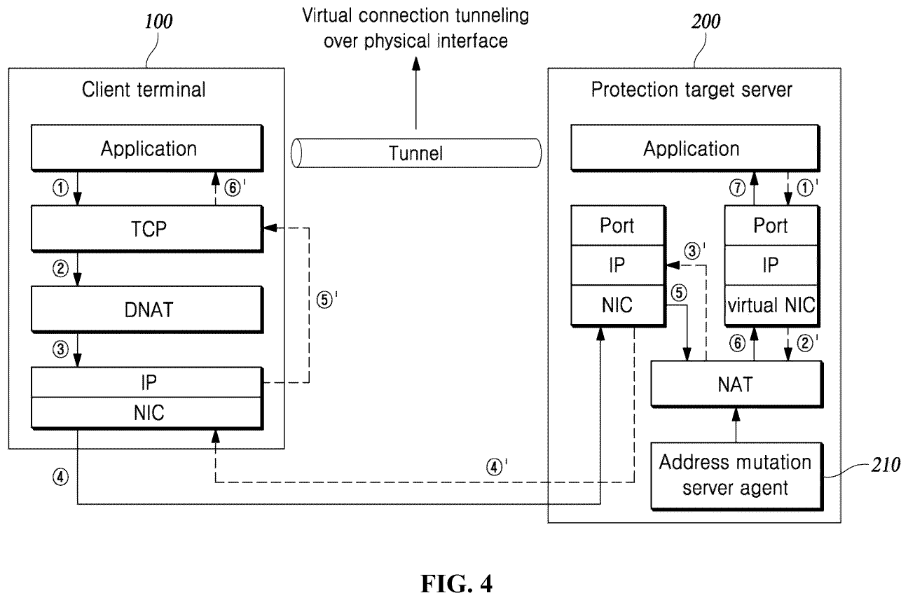

In this way, when the external address changes, all previously set network connections are bound to be disconnected. However, the system of the present invention maintains communication between the client terminal 100 and the protection target server 200. In order to ensure a smooth network connection although the external address changes, the system of the present invention applies virtual connection tunneling through a physical NIC. In order to establish a virtual connection through a physical NIC, the protection target server 200 requires a virtual NIC in addition to the physical NIC, and network connection for the physical NIC should be forced to be transferred to the virtual NIC. This will be described in detail in the architecture of FIG. 4.

In addition, the client terminal 100 should be assigned a virtual hidden address (hereinafter, also referred to as a virtual address) for accessing a protection target server desired by the terminal from the policy server 310, and should attempt a communication connection with the protection target server 200 using the assigned virtual address.

The protection target server 200 creates a virtual hidden tunnel together with an attempt of establishing a communication connection with the client terminal 100, and transmits and receives packets with the client terminal 100 through the created hidden tunnel.

Therefore, the encrypted communication system based on network address mutation according to an embodiment of the present invention has a characteristic in that it is a structure capable of dual encryption communication, in which a physical address that may access the protection target server 200 is not exposed to the outside by periodically and randomly mutating the physical address of the protection target server 200, i.e., an object to be protected, according to a mutation rule, and creating even the virtual connection tunneling provided to maintain the communication connection between the client terminal 100 and the protection target server 200, despite mutation of the physical address, as a virtual hidden tunnel that is hidden from external attackers.

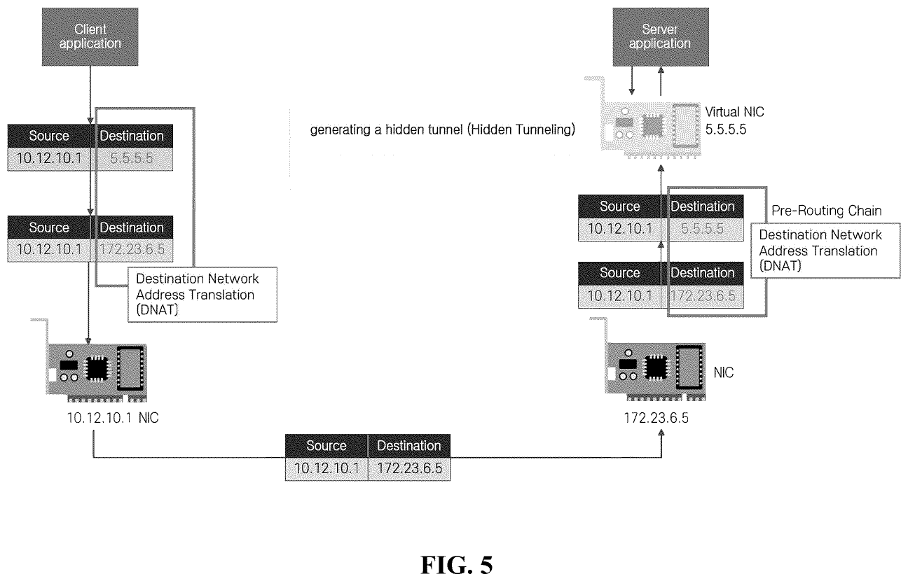

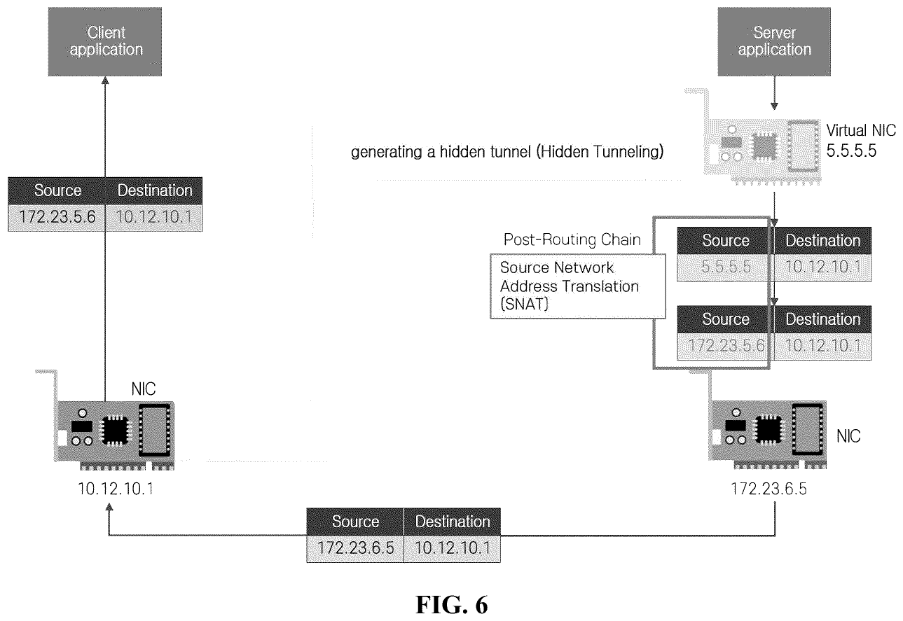

FIG. 4 is a view showing the architecture of a terminal and a server for accessing a virtual hidden tunnel using network address mutation according to an embodiment of the present invention, and FIGS. 5 and 6 are views showing examples of address translation in the process of packet request and response through the architecture of FIG. 4.

First, referring to FIG. 4, the architecture of the client terminal 100 includes TCP, Destination Network Address Translation (DNAT), IP, and physical NIC under the application layer.

The DNAT translates the virtual address assigned to the client terminal into the physical address of the protection target server, and the physical NIC means the Ethernet and transmits packets to the NIC of the server having the physical address address-translated by the DNAT. At this point, the DNAT of the client terminal translates the address with reference to the NAT table in which the address-mutated physical address is updated for the protection target server, and the NAT table is updated through the tracking module (110 of FIG. 2) of the client terminal 100.

The protection target server 200 includes TCP (Port), IP, server-side NIC, NAT, virtual NIC, IP, and Port under the application layer. In addition, the address mutation server agent 210 is included on top of the application layer.

The server-side NIC receives packets from the physical NIC of the client terminal, the server-side NAT address-translates the physical address back into the original virtual address to send the packets transferred to the server-side NIC to the virtual hidden tunnel, and the virtual NIC transfers packets of the virtual address address-translated by the server-side NAT to the virtual hidden tunnel. Through the configuration like this, the network connection for the physical NIC can be transferred to the virtual NIC.

In FIG. 4, the solid arrows (\textcircled{1} to \textcircled{7}) represent a request process in which the client terminal 100 sends a request to the protection target server 200, and the dotted arrows (\textcircled{1}′ to \textcircled{6}′) represent a packet transmission process in which the protection target server 200 responds to the client terminal 100.

In order for the application of the client terminal 100 to communicate with the application of the protection target server 200, the application layer attempts a communication connection using a virtual address assigned from the policy server (\textcircled{1}). At this point, since the virtual address is a hidden address that is not exposed to the outside, in order for a packet to be transferred to the protection target server 200, the virtual address should be changed to the physical address of the server. Thereafter, the DNAT of the client terminal translates the virtual address of the server to the physical address (\textcircled{3}), and the packet is transferred to the physical NIC of the protection target server through the physical NIC of the client terminal 100 (\textcircled{4}) The packet transferred to the server side requires address translation once more in order to access the channel of the virtual hidden tunnel, that is, the server-side NAT translates the physical address address-translated by the client terminal 100 back into the original virtual address (\textcircled{5} and \textcircled{6}), and transfers the packet to the corresponding hidden tunnel through the virtual NIC (\textcircled{7}).

For example, as shown in FIG. 5, when the source IP address is 10.12.10.1 and the destination IP address is 5.5.5.5, the source is the client terminal and the destination is the protection target server from the perspective of the client terminal that transmits the packet to the server. Here, 5.5.5.5 is a virtual address. Accordingly, this virtual address is translated into the physical address 172.23.6.5 by the DNAT of the client terminal, and the packet is transferred to the server side, and the protection target server that receives the packet through the server-side NIC address-translates the physical address 172.23.6.5 back into the original virtual address 5.5.5.5 inside thereof.

Referring to FIG. 4 again, when the protection target server 200 transmits are sponse packet to the client terminal 100 (\textcircled{1}′), the virtual address of the server should be translated into a physical address so that the packet can be moved to the NIC of the client terminal through the server-side NIC. At this point, the source is the virtual address 5.5.5.5 of the protection target server as exemplified in FIG. 6, and the destination is the IP address 10.12.10.1 of the client terminal. That is, the protection target server 200 sets the virtual address of the server as the source address, address-translates the virtual address of the source address into a physical address through the NAT (\textcircled{3}′), and transmits the packet to the physical NIC of the client terminal through the server-side NIC (\textcircled{4}′). Then, the client terminal 100 directly transfers the packet to the application layer without the need of address translation (\textcircled{5}′, \textcircled{6}′).

The configuration of performing encrypted communication using virtual tunneling to maintain the communication connection between the client terminal and the server although the physical address of the server continuously mutates has been described above.

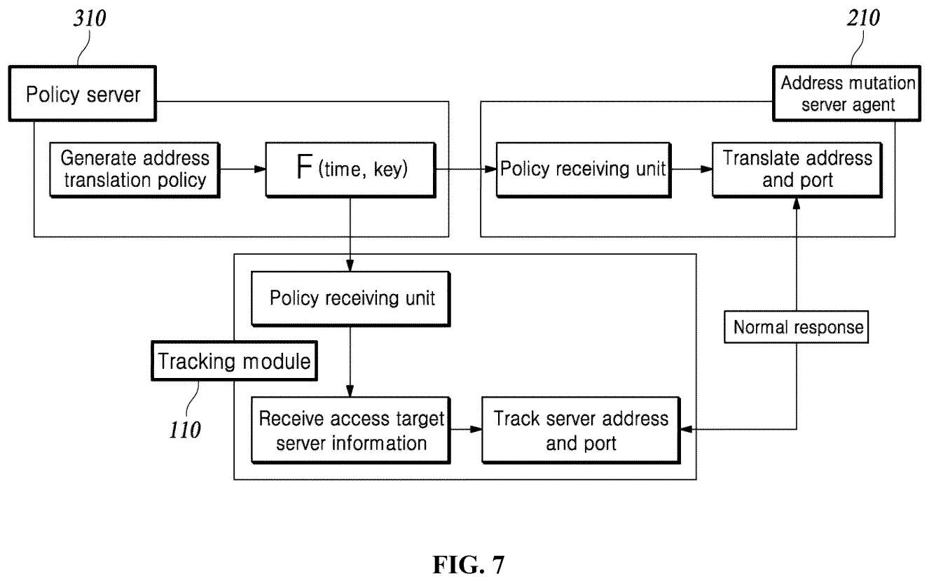

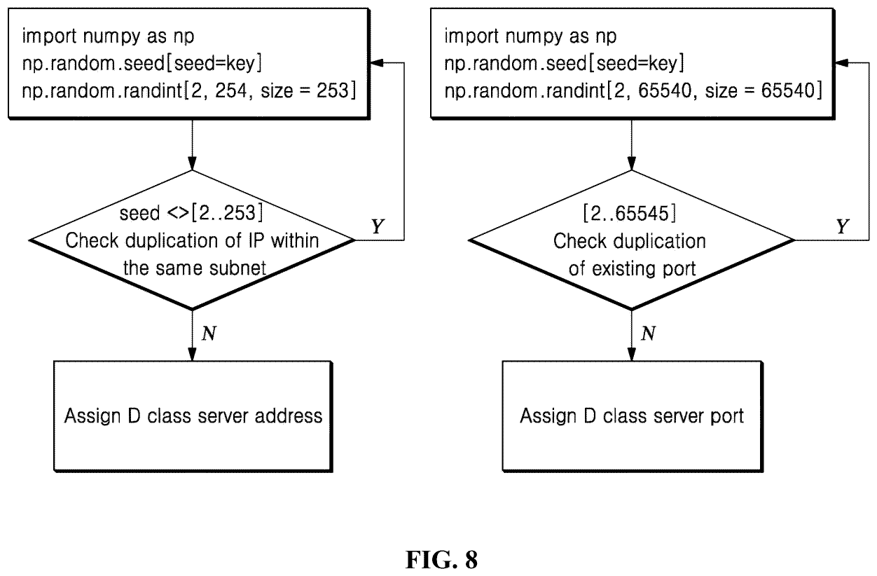

Then, hereinafter, the configuration for continuously mutating the physical address of the server will be described with reference to FIGS. 7 and 8.

FIG. 7 is a view showing a configuration of mutating an address through a policy server in a system according to an embodiment of the present invention, and FIG. 8 is a view showing an algorithm for random address generation in the policy server of FIG. 7.

First, referring to FIG. 7, address mutation of the server relates to the policy server 310, the tracking module 110 of the client terminal, and the address mutation server agent 210 of the protection target server.

Since both legitimate users and attackers cannot normally access when the physical address of the server continuously changes, legitimate users should be able to acquire a policy that can track the server in real time, and before that, the server should register a policy about the rule of performing address mutation in the policy server 310.

The policy server 310 generates an address mutation policy of a corresponding server by setting the service information, address mutation cycle and range, and the like provided by the server through the registration procedure of the protection target server 200. The mutation policy uses a random function (F(time, key)) related to the time and a secret key, and the time of the random function is that the operating systems of the server and the client terminal should be synchronized in time. The operating systems only need to be synchronized to the same standard time. For example, there is no problem although they are in different time zones on the basis of the UTC standard time. The secret key is linked to the authentication system, and when a policy is registered in the policy server 310, the authentication system generates a secret key for the server, and this secret key is shared only with terminals authenticated to zero trust.

The address mutation server agent 210 of the protection target server receives a previously registered policy from the policy server 310 through a policy receiving unit, and randomly translates the address and port according to the mutation rule of the policy.

When the client terminal performs authentication through an authentication means (e.g., OTP) and selects a service to use, the tracking module 110 of the client terminal acquires the policy and the secret key of the server that provides the corresponding service from the policy server 310, and tracks in real time an address the same as the address of the server using this information whenever the address of the server changes. The address at this point means the physical address of the protection target server.

As shown in FIG. 8, the random function generates a random value using the secret key distributed through the authentication system, and confirms whether the generated random value is duplicated in the IP address range or port number range (IP duplication check, port duplication check), and when there is no duplicated value, the random function assigns the random value as a D class server address or a D class server port number.

Meanwhile, in the system according to an embodiment of the present invention, the wider the range of moving a valid tunnel, the higher the attack cost and load. The total number of tunnels can be regarded as the movement range of a valid tunnel.

Since the maximum number of ports is fixed, the easiest way of extending the movement range is to assign more IP addresses to the server. However, since IP addresses are limited resources, the embodiment of the present invention uses an extended tunnel identifier that adds a source port number, instead of increasing the number of IP addresses that can be used to extend the movement range. That is, the address mutation range is extended by further including the source port number, in addition to the IP address and port number of the server.

The range of address mutation of a packet described above is the number of assigned IP addresses and port numbers applied to a protected asset (a server, etc.), and the tunnel identifier due to the address mutation is the IP address and port number. When the source port number is added as a tunnel identifier, the movement range of a valid tunnel is 253×2¹⁶×2¹⁶. Although only one IP address may be assigned to the server, the total number of tunnels is 2³².

Therefore, since an active attacker only acquires the IP address and port number of the target server, the active attacker cannot accurately identify a valid tunnel identifier added with the source port number. In conclusion, it is possible to perfectly hide an access address of the target server from the active attacker.

A passive attacker can identify even the source port number of a valid tunnel through packet scanning. However, it is general that the source port number is automatically assigned by the operating system. Therefore, it is a large burden for external attackers to identify a valid source port number before the mutation cycle changes. It has an effect of greatly increasing the attack load.

In the communication system through virtual tunneling (MTN; Moving Tunnel Networking) of an embodiment of the present invention, adding a source port number to a tunnel identifier is simple. A server and a client that periodically generate synchronized IP addresses and port numbers generate an additional port number and use it as a source port number identifier. To change the source port number of a packet generated on the client side to this port number, a source NAT module may be further included, for example, at the rear end of the DNAT of the client terminal 100 in FIG. 3. Since the server does not need to know the source port number of the client, an additional NAT is not required in the protection target server. However, the DNAT of the protection target server should be applied only to packets in which all of the destination IP address, destination port number, and source port number are valid.

Meanwhile, in the system according to an embodiment of the present invention, when the address mutation cycle of the protection target server changes before the packet transmitted from the client terminal arrives at the protection target server, a situation in which the packet transmitted by the client terminal does not reach the server and the virtual connection fails may occur.

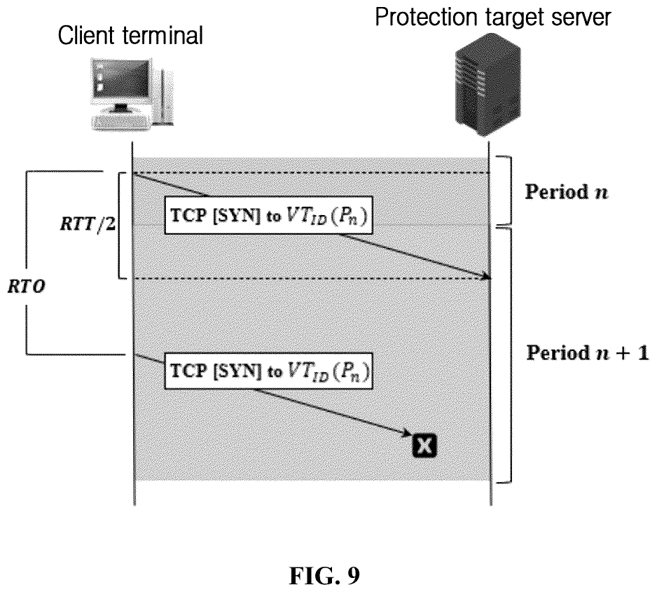

FIG. 9 is a view for explaining an example of a failed virtual connection in a system according to an embodiment of the present invention. A virtual connection failure occurs as the NAT tables of the protection target server and the client terminal are updated at the boundary where the mutation period changes before a TCP[SYN] packet sent by the client terminal arrives at the server. The client terminal sends the TCP[SYN] packet to the server through VTID(n), and generates connection tracking information for VTID(n). Thereafter, the valid tunnel identifier is changed to 1before the VTID(n+1) packet arrives at the server. When the TCP[SYN] packet arrives at the server, the packet is discarded since the server does not have connection tracking information for the packet and the destination address VTID(n)of the packet is different from the valid tunnel identifier VTID(n +1) of the server.

At this point, since the client terminal does not receive a response from the protection target server, it retransmits the TCP[SYN] packet due to the retransmission timeout (RTO). Although the client terminal has already updated the valid tunnel identifier in the NAT table to VTID(n+1), the updated NAT rule is ignored since the retransmitted TCP[SYN] packet is affected by the connection tracking information for VTID(n). As a result, the client terminal falls into a deadlock state in which it sends packets only to VTID(n) that does not receive a response from the protection target server.

There are two ways to resolve this deadlock.

The first method is to overlap valid tunnels.

For example, in FIG. 9, during a short period of time before and after the time boundary when the address mutation cycle changes, the address mutation server agent of the protection target server guarantees to accept all TCP[SYN] packets incoming through VTID(n) or VTID(n+1). Since the time taken for the TCP[SYN] packet transmitted from the client terminal to arrive at the protection target server is half of the round-trip time (RTT), the valid tunnel overlap time should be longer than the sum of RTT/2 and an appropriate constant value (k) that considers the variation (RTT/2 +k). When the tunnel movement cycle is shorter than this, the duration time cannot be defined. Accordingly, when the first method is used, the shortest tunnel movement cycle is RTT/2+k.

The second method is that the client terminal periodically deletes the connection tracking information that induces deadlock. In other words, it is set to prevent packets from being deadlocked by the NAT table before the mutation cycle by deleting the connection tracking information before and after the mutation cycle and retransmitting packets when the client terminal attempts retransmission of a failed packet using the physical address updated at the retransmission timeout.

When the connection tracking information is deleted, retransmitted TCP[SYN] packets are affected by the updated NAT table, and the client application program is released from the deadlock. This is performed through the tracking module of the client terminal.

Comparing these two solutions, although the first method can prevent deadlock at all times, security is lowered as the number of valid tunnels is doubled during the duration time. Although the second method can prevent the deadlock from being persistent in the situation of FIG. 9, virtual connection setting is delayed as the deadlock occur more than once. Therefore, it is preferable to adopt the second method when security is more important, and adopt the first method when performance is more important.

A shortest tunnel movement cycle that guarantees stability is defined on the basis of the solution for a failed case. As mentioned in the first solution, the minimum value of a period allowed for overlapped valid tunnels is RTT/2+k. Therefore, when the tunnel movement cycle is shorter than this, the duration time cannot be defined. Consequently, when the first method is used, the shortest tunnel movement cycle is RTT/2+k. In the second solution, the failed case may be repeated in reality when the valid tunnel is moved again before a retransmitted packet reaches the server after the client deletes the connection tracking information that induces deadlock. Although this case is very rare, in order to reduce the probability of virtual connection failure to 0%, the tunnel should not move within the RTO, and the time for the retransmitted packet to reach the server should be considered. Accordingly, the shortest tunnel movement cycle of the second method may be defined as RTO+(TT/2)+k.

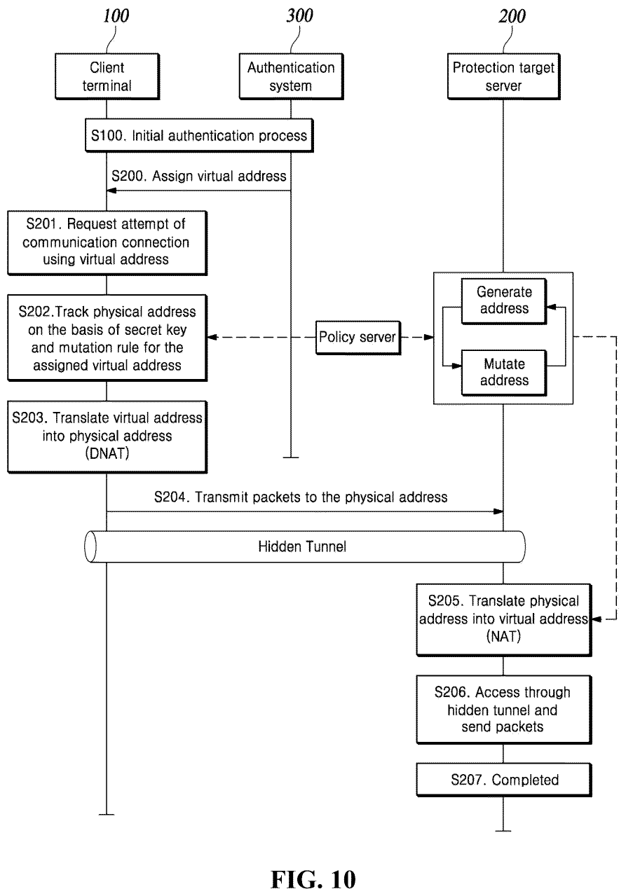

FIG. 10 is an overall flowchart for explaining an encrypted communication method based on network address mutation according to an embodiment of the present invention.

First, an initial authentication process is performed between the client terminal 100 and the authentication system 300 (S100).

The initial authentication process should be performed to generate and safely manage addresses used in the network address mutation of the present invention.

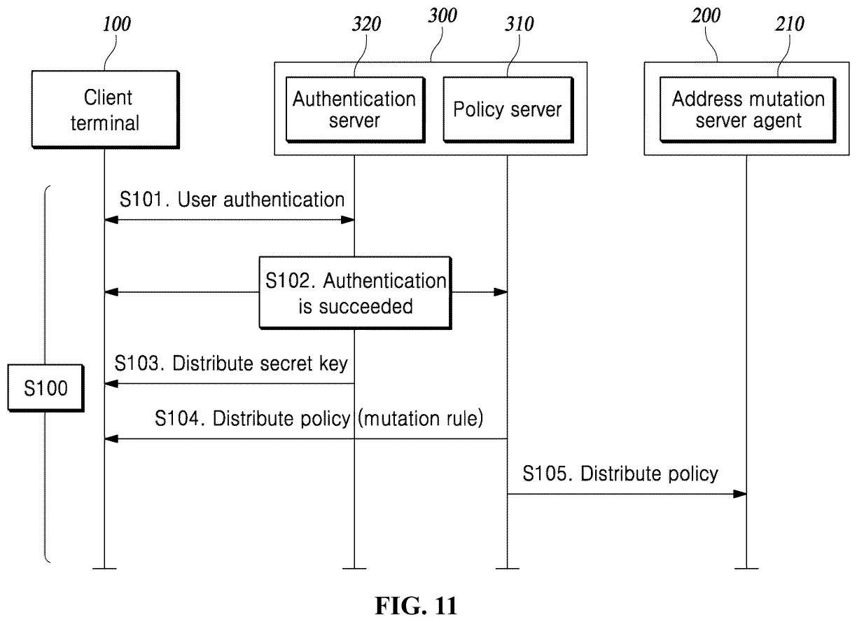

The initial authentication process includes a user authentication process between the client terminal 100 and the authentication system 300, and a process of distributing policy information and a secret key of a server, a service of which the terminal desires to use, to a terminal that has succeeded in user authentication. This will be described below in detail in FIG. 11.

Before the initial authentication process, a process of registering a policy by the protection target server is further included.

That is, a policy of mutating the physical address of the server at regular intervals is registered in the policy server on the basis of the service information, address mutation cycle and range, and lifecycle provided by the protection target server, and in response thereto, the protection target server performs a function of receiving the policy of the server from the policy server and mutating the physical address of the server according to the address mutation cycle and range included in the mutation rule of the policy.

Next, the client terminal 100 succeeded in zero trust through the initial authentication process is assigned a virtual address for accessing a protection target server desired by the terminal from the policy server of the authentication system 300 (S200). The virtual address is an encrypted hidden address invisible from the outside.

Next, the client terminal 100 attempts a communication connection with the protection target server 200 using the assigned virtual address (S201).

Specifically, the tracking module of the client terminal 100 receives a policy and a secret key corresponding to the protection target server from the policy server, and tracks the physical address of the protection target server with reference to the mutation rule of the policy when attempting a communication connection with the protection target server (S202). The tracked physical address of the protection target server is updated in the NAT table.

In addition, the tracking module of the client terminal is further configured to perform a process of updating the NAT table by continuously tracking the physical address of the protection target server, which is mutated at regular intervals according to the mutation rule defined in the policy.

Next, the Network Address Translation(NAT) of the client terminal translates the virtual address assigned in the previous process into a corresponding physical address with reference to the NAT table (S203).

Next, the client terminal transmits packets to the physical address of the server through the Ethernet (physical NIC) (S204). The packets are transferred to the physical Ethernet address of the protection target server through the physical NIC of the client terminal.

At this point, a hidden tunnel is created between the client terminal 100 and the protection target server 200 owing to the virtual address assigned to the terminal. The created hidden tunnel becomes a communication channel through which the client terminal 100 and the protection target server 200 communicate.

Accordingly, the protection target server 200 performs an address translation process of translating a physical address into a virtual address so that the packets transferred to the server-side Ethernet are sent through a virtual hidden tunnel (S205).

Next, the protection target server 200 transfers the packets of the address-translated virtual address to the hidden tunnel through the virtual Ethernet (S206).

Through the process like this, packet transmission is completed through virtual connection tunneling between the client terminal 100 and the protection target server 200 (S207).

FIG. 11 is a flowchart for explaining an authentication process between a client terminal and an authentication server in an encrypted communication method according to an embodiment of the present invention.

As the initial authentication process (S100) for encrypted communication of the present invention, the client terminal 100 performs user authentication in association with the authentication server 320 of the authentication system 300 (S101).

For example, the authentication server 320 authenticates the user by managing the ID and password of the client terminal 100, and assigns and registers identification information or authentication means (OPT) in the client terminal 100 succeeded in user authentication. Accordingly, the client terminal 100 requests authentication using the OTP assigned by the authentication server 320 and be assigned a virtual address of the protection target server from the authentication server 320 or the policy server 310.

Next, when the authentication server 320 succeeds in user authentication, it feeds back a response to the client terminal 100 and the policy server 310 (S102).

Next, the authentication server 320 distributes the secret key of the protection target server desired by the client terminal 100 that has succeeded in user authentication (S103).

At the same time, among the previously registered policies, the policy server 310 distributes the policy of a protection target server desired by the terminal to the client terminal 100 (S104).

In addition, the policy server 310 distributes the policy and secret key of the server to the address mutation server agent 210 of the protection target server 200 (S105).

Through the process, the present invention allows only the client terminals that have completed zero-trust authentication to access the protection target server, and enables the client terminals to track, in real time, the address of the server that is frequently changed by the address mutation server agent.

The features, structures, effects, and the like described in the present invention described above are included in at least one embodiment of the present invention, and are not necessarily limited to only one embodiment. Furthermore, the features, structures, effects, and the like exemplified in each embodiment can be combined or modified by those skilled in the art to be implemented in other embodiments. Therefore, the contents related to such combinations and modifications should be interpreted as being included in the scope of the present invention.

In addition, although it has been described focusing on the embodiments, these are only examples and do not limit the present invention, and those skilled in the art will recognize that various modifications and applications not exemplified above are possible without departing from the essential characteristics of the present invention. For example, each component specifically shown in the embodiments can be modified and implemented. In addition, the differences related to such modifications and applications should be interpreted as being included in the scope of the present invention defined in the appended claims.

### Industrial Applicability

As a virtual hidden communication channel is created to maintain a communication connection between a protection target server and a client, while continuously mutating the actual address of the protection target server at short intervals, the actual address of a server to be accessed is not exposed to the outside at all through a dual encryption communication channel, and all network scanning attacks can be suppressed. Therefore, the present invention has industrial applicability from the aspect of network security techniques, information protection-related techniques, and various cyber-attack defense techniques.

1. A system for securely moving encrypted communication based on network address mutation, the system comprising:
a policy server for registering and managing a policy for mutating a physical address of a server on the basis of service information, address mutation cycle and range, and life cycle provided by the server;
a client terminal which, upon successful authentication, is assigned a virtual hidden address enabling access a protection target server desired by a terminal from the policy server, and attempts to establish a communication connection with the protection target server using the assigned virtual address; and
the protection target server including an address mutation server agent configured to receive, from the policy server, a policy of mutating a physical address of a corresponding server, and to mutate the physical address at regular intervals according to a mutation rule of the policy, in order to transmit or receive packets to or from the client terminal through the hidden tunnel by generating a hidden tunnel so that the communication connection is maintained through the virtual address assigned to the client terminal although the physical address is mutated by the address mutation server agent,
wherein dual encryption communication is enabled so that the physical address capable of accessing the protection target server is not exposed to the outside.

2. The system according to claim 1, wherein the client terminal includes:
a tracking module for receiving a policy corresponding to the protection target server from the policy server, and tracking the physical address of the protection target server with reference to the mutation rule of the policy when attempting a communication connection with the protection target server;
a Network Address Translation (NAT) for address-translating the assigned virtual address into a physical address of the protection target server tracked through the tracking module; and
a physical NIC for transmitting packets to the physical address address-translated by the NAT.

3. The system according to claim 2, wherein the tracking module continuously tracks the physical address of the protection target server mutated at regular intervals according to the mutation rule of the policy, and updates an NAT table.

4. The system according to claim 2, wherein the protection target server includes:
a server-side NIC for receiving packets from the NIC of the client terminal;
a server-side NAT for address-translating the physical address back into the virtual address to send the packets transferred to the server-side NIC through the virtual hidden tunnel; and
a virtual NIC for transferring packets of the virtual address address-translated by the server-side NAT to the virtual hidden tunnel.

5. The system according to claim 4, wherein when transmitting aresponse packet to the client terminal, the protection target server sets the virtual address connected to the client terminal as a source address, address-translates the virtual address of the source address into a physical address through the NAT, and then transmits the packets to the physical Ethernet of the client terminal through the server-side NIC.

6. The system according to claim 5, wherein when translating the virtual address of the source address into a physical address, the protection target server address-translates the address into a physical address address-translated through the address mutation server agent, and the client terminal receives packets from the protection target server with reference to the physical address of the server, of which the tracking has been updated through the tracking module, without receiving information on the address-mutated physical address from the protection target server.

7. The system according to claim 1, wherein the address mutation server agent extends the address mutation range by further including a source port number of the protection target server, in addition to the IP address and port number of the protection target server.

8. The system according to claim 1, wherein when the address mutation cycle of the protection target server changes before the packets transmitted from the client terminal arrive at the protection target server, the address mutation server agent guarantees to accept, for a short period of time before and after the address mutation cycle is changed, the packets received through the physical address before the change of address mutation cycle, or the tracking module of the client terminal is set to delete connection tracking information before and after the mutation cycle when the client terminal attempts to retransmit a failed packet using an updated physical address so that the packets are not dead locked by the NAT table before the mutation cycle when the packets are retransmitted.

9. The system according to claim 1, further comprising an authentication server for generating a secret key for the protection target server, performing a user authentication process with the client terminal, and distributing the secret key and policy for a protection target server desired by the client terminal to the client terminal that succeeds in authentication, wherein the address mutation server agent performs address mutation by generating a random value using the secret key generated through the authentication server.

10. A method for securely moving encrypted communication based on network address mutation, the method comprising the steps of:
registering a policy for mutating a physical address of a server in a policy server on the basis of service information, address mutation cycle and range, and life cycle provided by the server;
receiving a policy of a corresponding server from the policy server through an address mutation server agent, and mutating the physical address of the server at regular intervals according to a mutation rule of the policy, by the protection target server;
being assigned a virtual hidden address for accessing a protection target server desired by a client terminal from the policy server, and attempting a communication connection with the protection target server using the assigned virtual address, by the client terminal; and
generating a hidden tunnel so that the communication connection is maintained through the virtual address assigned to the client terminal although the physical address is mutated through the address mutation server agent, and receiving packets transmitted from the client terminal through the hidden tunnel, by the protection target server,
wherein dual encryption communication is enabled so that the physical address capable of accessing the protection target server is not exposed to the outside.

11. The method according to claim 10, wherein the step of attempting a communication connection with the protection target server using the assigned virtual address by the client terminal includes the steps of:
receiving a policy corresponding to the protection target server from the policy server, and tracking the physical address of the protection target server with reference to the mutation rule of the policy when attempting a communication connection with the protection target server, by the tracking module of the client terminal;
address-translating the assigned virtual address into a physical address of the protection target server tracked through the tracking module, through Network Address Translation (NAT), by the client terminal; and
transmitting packets to the address-translated physical address through Ethernet, by the client terminal.

12. The method according to claim 11, further comprising the step of continuously tracking the physical address of the protection target server mutated at regular intervals according to the mutation rule of the policy, and updating an NAT table, by the tracking module of the client terminal.

13. The method according to claim 11, wherein the step of receiving packets transmitted from the client terminal by the protection target server includes the steps of:
receiving packets from the Ethernet of the client terminal through server-side Ethernet, by the protection target server;
address-translating the physical address back into the virtual address through a server-side NAT so that the packets transferred to the server-side Ethernet are sent through the virtual hidden tunnel, by the protection target server; and
transferring the packets of the address-translated virtual address to the virtual hidden tunnel through the virtual Ethernet, by the protection target server.
